(19) United States
(12) Patent Application Publication
(10) Pub. No.: US 2024/0084874 A1
(43) Pub. Date: Mar. 14, 2024

(54) Shock Absorber

(71) Applicant: Wheel Pros, LLC, Greenwood Village, CO (US)

(72) Inventors: Mark Regner, Salt Lake City, UT (US); Michael Owens, Salt Lake City, UT (US)

(73) Assignee: Wheel Pros, LLC, Greenwood Village, CO (US)

(21) Appl. No.: 18/244,663

(22) Filed: Sep. 11, 2023

Related U.S. Application Data
(60) Provisional application No. 63/405,365, filed on Sep. 9, 2022.

(51) Int. Cl. F16F 13/06; F16F 9/06; F16F 9/348; F16F 9/36; F16F 9/43; F16F 9/48; F16F 9/58

(52) U.S. Cl. CPC F16F 13/06; F16F 9/061; F16F 9/065; F16F 9/348; F16F 9/36; F16F 9/43; F16F 9/483; F16F 9/585; B60G 15/067; B60G 2204/128; B60G 2204/129; F16F 2222/12; F16F 2228/066; F16F 2230/0005; F16F 2230/007; F16F 2230/06; F16F 2230/30; F16F 2230/42; F16F 2232/08; F16F 2234/02

(57) ABSTRACT

A shock absorber has a main piston and a compression piston, connected by a compression piston housing. In stage 1, the shock absorber operates as a conventional monotube, with the damping force being generated only by the main piston. In stage 2, the compression piston travels into the compression housing, as the shock absorber still operates as a monotube damper. In stage 3, the compression piston is now significantly increasing its compression damping force by supplementing the main piston. The oil volume in the compression piston housing passes through the compression piston, causing an increase in compression damping force.

### CROSS REFERENCE TO RELATED APPLICATIONS

This utility patent application claims priority from U.S. Provisional Application No. 63/405,365, filed Sep. 9, 2022, the contents of which are incorporated by reference into this utility patent application.

### STATEMENT REGARDING FEDERALLY SPONSORED RESEARCH OR DEVELOPMENT

This invention was not federally sponsored.

### INVENTORS

Mark Regner and Michael Owens, both residents of Salt Lake City and citizens of USA.

### BACKGROUND OF THE INVENTION

Field of the invention: This invention relates to the general field of shock absorbers, and more specifically, to a novel shock absorber that has a main piston and a compression piston working in synergistic cooperation to provide a smoother ride.

General Field. Shock absorbers have been part of the automotive industry since the early 1900's. As the speed at which cars traveled increased, the jarring caused by wheels moving over road irregularities became more and more of a problem, both to the riders' comfort and to the car's physical condition. The first patent for a shock absorber was granted in 1907 to Frenchman Maurice Houdaille, and the technology has evolved considerably over the succeeding hundred-plus years.

More correctly called “friction dampers” the term “shock absorber” is not really a correct description of what actually occurs—“shock absorbers” do not absorb shocks, but rather they dampen leaf spring oscillations caused by the wheels of a vehicle moving up and down as the encounter bumps and dips in the road.

Basic physics causes a spring that is deflected as the vehicle bounces over a rock or into a pothole to move past its original position and oscillate back and forth until its energy dissipates. This is obviously undesirable, as a rider ill be comfortable feeling the aftereffects of a bump for several minutes. So, dampers or “shock absorbers” were invented to control and dampen the oscillation by taking the kinetic energy of the suspension and transforming that kinetic energy into thermal energy that is dissipated by hydraulic fluid.

Nearly 120 years after the first patent on a shock absorber, there are two main types of shock absorber/damper technologies used in most OEM and AM arenas: the monotube and the twintube. In older damper technology, it usually held true that the difference was immediately apparent by the number of tubes used. Now with companies developing active and semi-active technology, this is no longer the case. It is not uncommon for a semi-active monotube to actually use two tubes in their construction, and for semi-active twin tubes to use three tubes in theft construction.

The key point that separates the two damper types is that a monotube does not have a gas and oil mixture. They are typically high pressure. A twintube does have gas and oil mixture. There is no isolation for the two fluid volumes, and they are often low pressure. Currently, Falcon Performance Shocks only manufactures monotube dampers.

Prior Art. Since the history of shock absorbers goes back over 100 years, it is understandable that there is considerable prior art in this field. Among the most pertinent prior art are several patents and published patent applications.

One such prior art is US publication 20220128114 to BeijingWest Industries Co. Ltd, which describes a hydraulic damper assembly comprises a housing extending between a first end and a second end. A main piston is slidably disposed in the fluid chamber dividing the fluid chamber into a first chamber and a second chamber. A piston rod extends along a center axis and attaches to the main piston. An additional piston is coupled to the piston rod and axially spaced from the main piston. The additional piston includes a main body defining a compression channel and a rebound channel that allows fluid to flow through the additional piston. A securing member secures the additional piston to the piston rod and defines an outer groove. A piston ring is located in the outer groove between the additional piston and the securing member. The piston ring is radially spaced from the securing member to allow the piston ring to be engaged with the housing.

While this invention is a twintube damper and therefore uses an inner tube and bottom valve to achieve standard damping as well as the supplemental compression damping. Due to the gas/oil mixture, it will likely not be capable of producing a significantly higher damping force from standard performance.

Other prior art is found in DE202019101886U1 to ThyssenKrupp AG, ThyssenKrupp Bilstein of America Inc, which describes a vibration damper for a motor vehicle with at least one damper tube and a piston rod, which comprises a main piston and at least one first separate valve piston, which at a pressure stage in a first end position area (1 of the damper tube cooperates with a first catching piston to increase the end position damping force, the first catching piston being movably arranged in the first end position area, characterized in that the piston rod has at least one second separate valve piston, which cooperates with the second stopping piston in a rebound stage in a second end position area of the damper tube to increase the end position damping force, the second stopping piston being movably arranged in the second end position area.

This invention is a monotube damper with a more complexity than the current invention. The Bilstein product requires the addition of a “catch piston”, “crimp ring”, and spring (24, 27 and 25) to achieve their supplemental compression damping. This system is also tunable by changing the spring length as well as having the ability to valve to supplemental piston. The current invention is fixed, and orifice based. Because of this, the content of the current invention is significantly less complex and does not have the added expense from additional components.

A third relevant prior art is found in EP2531744B1 to Cambridge Enterprise Ltd, Penske Racing Shocks Inc, for a Damping and inertial hydraulic device. This invention is for use in the control of mechanical forces. The device comprises first and second terminals for connection, in use, to components in a system for controlling mechanical forces and independently moveable. Hydraulic means are connected between the terminals and contain a liquid, the hydraulic means configured, in use, to produce upon relative movement of the terminals, a liquid flow along at least two flow paths. The liquid flow along a first flow path generates a damping force proportional to the velocity of the liquid flow along the first flow path, and the liquid flow along a second flow path generates an inertial force due to the mass of the liquid, the force being substantially proportional to the acceleration of the liquid flow along the second flow path, such that the damping force is equal to the inertial force and controls the mechanical forces at the terminals.

This is a monotube inverter shock with a supplemental working piston. It appears that this valve functions more as a parallel operating piston rather than a supplemental performance piston. It also appears that they are both tied in with the inverter system shown in FIG. 16. It does not appear to offer any position dependent damping or position sensitive supplemental damping.

Further prior art is found in DE132021202624A1 to ThyssenKrupp AG, ThyssenKrupp Bilstein of America Inc for a damper with a main damper assembly includes a damper tube with a damping fluid. A main working piston divides a main fluid chamber into a piston rod side and a non-piston rod side. The main fluid chamber has an upper zone, a lower zone and a central zone. A secondary damper assembly with a secondary working piston is in fluid communication with the main damper assembly. When the main working piston moves in the central zone, fluid is caused to flow through the main working piston and secondary working piston to create a first damping force, and when the main working piston moves in either the upper or lower zone, fluid is caused only flows through the main working piston to generate a second damping force, the first damping force being less than the second damping force.

This is a monotube bypass shock with a compression and rebound supplementing base valve. This is position dependent due to the location of the bypass ports/orifices and uses a stationary base valve to supplement damping. The design creates position sensitive damping but likely does not create a percentage increase like that of the Falcon product or Result 2. Complexity and cost are also significant due to the need for external hoses.

Another publication of interest is US20180194186A1 to Ford Global Technologies LLC for a shock absorber having internal jounce control, which includes an inner tube defining a cavity and an outer tube surrounding the inner tube to define a reservoir between the inner tube and the outer tube. The cavity is in fluid communication with the reservoir. A jounce bumper is positioned in the reservoir between the inner tube and the outer tube.

This is a twintube damper with no supplemental compression valve. As the rod is compressed into the damper, this fluid must be displaced. In this design it appears that there is a typical twintube gas/oil mixture and an MCU bumper inside the damper. This is acting at the end of travel just as the external jounce bumper. Unlike the current invention, this is not a hydraulic tech solution.

A final patent of note is U.S. Pat. No. 8,746,423B2 to Hitachi Astemo Ltd for a shock absorber with an inclined surface that is inclined to a moving direction of the free piston in at least one of a free piston contact surface of a free surface with which an elastic body is in contact and a housing contact surface of a housing with which the elastic body is in contact. The shortest distance contact surface is changed by movement of the free piston between the free piston contact surface and the housing.

This is a monotube shock where an additional valve creates an amplitude dependent characteristic for ride. As in, bypass is avowed hi low amplitude situations. This is not position-sensitive as compared with the current invention.

Despite the numerous inventions that have tried to improve upon the shock absorber, there are none that provide the coordinated shock absorption capacity of two connected piston portions.

The current invention provides a solution for this long-felt need by providing a shock absorber with both a main piston and a compression piston. The two pistons are connected by a compression piston housing. When the spring is first deflected by the tire running over a rock or pothole, the shock absorber operates as a conventional monotube, with the damping force being generated only by the main piston. In stage 2 of the process, the compression piston travels into the compression housing, as the shock absorber still operates as a monotube damper. In stage 3 of the process, the compression piston is now significantly increasing its compression damping force by supplementing the main piston. The oil volume in the compression piston passes through the compression piston, causing an increase in compression damping force.

### OBJECTS OF THE INVENTION

It is therefore an object of the present invention to provide a shock absorber that is simple in construction, and yet combines two piston portions to provide a superior shock absorption.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a cross-sectional view of a first embodiment of the invention.

FIG. 2 is a close-up view of the upper portion of the embodiment illustrated in FIG. 1 in a first phase of operation.

FIG. 3 is a close-up view of the upper portion of the embodiment illustrated in FIG. 1 in a second phase of operation.

FIG. 4 is a close-up view of the upper portion of the embodiment illustrated in FIG. 1 in a third phase of operation.

FIG. 5 is a cross-sectional view of a second embodiment of the invention with a close-up view of the check disc portion of the invention.

FIG. 6 is a close-up view of the upper portion of the embodiment illustrated in FIG. 5 in a first phase of operation.

FIG. 7 is a close-up view of the upper portion of the embodiment illustrated in FIG. 5 in a second phase of operation.

FIG. 8 is a close-up view of the upper portion of the embodiment illustrated in FIG. 5 in a third phase of operation.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

As a general overview, the invention provides a novel shock absorber where a main piston and a compression piston are connected by a compression housing. In a first stage of compression, the shock absorber operates as a conventional monotube, with the damping force being generated only by the main piston. In a second stage, where the load on the shock absorber becomes greater, the compression piston travels into the compression housing, but the shock absorber still operates as a monotube damper. In a third stage, the compression piston significantly increases its compression damping force by supplementing the main piston. The oil volume in the compression piston passes through the compression piston, causing an increase in compression damping force.

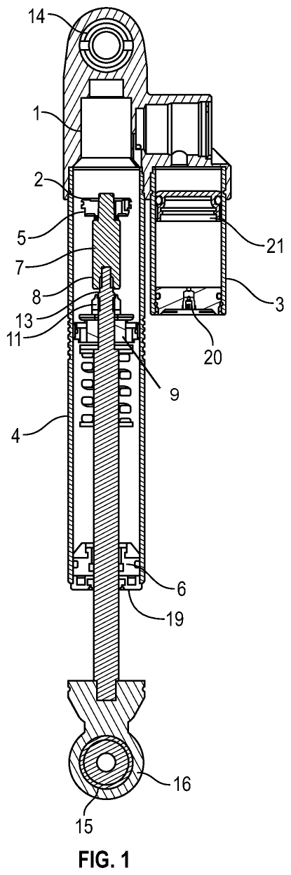

FIG. 1 is a cross-sectional view of a first embodiment of the invention. A shock absorber has an upper eyelet 16 with an upper bushing 15. A body cap with hydraulic compression 1 sits above a damper body 4.

The damper body 4 is bounded on one end by a jounce cap 19, which a connected to the damper body by a seal head assembly 6. Inside the damper body 4, a damper shaft with hydraulic jounce post 13 connects the upper eyelet 16 to various pistons. A main working piston nut 11 secures a main working piston 9 to the damper shaft with hydraulic jounce post 13.

In a first embodiment of the invention, a check disc 2 is attached to a top section of the damper shaft with hydraulic jounce post 7, with a hydraulic jounce piston 5 secured below the check disc 2 by a hydraulic jounce piston valve stack 7 and a hydraulic jounce piston valve stack nut 8 to the damper shaft with hydraulic jounce post 13.

To the side of the body cap with hydraulic compression 1, is a reservoir body 3. The reservoir body 3 has a gas fill plug assembly 20 which is used to fill the reservoir body. Inside the reservoir body 3, an oil/gas separating piston 21 provides additional shock absorbing capabilities. Connecting the reservoir body 3 to the damper body 4 are an adjustable base valve assembly 24, which comprises a base valve adjustment indicator 22 which shows what adjustable base valve setting is currently selected, a base valve adjustment indicator 23 which indicates the setting of the knob.

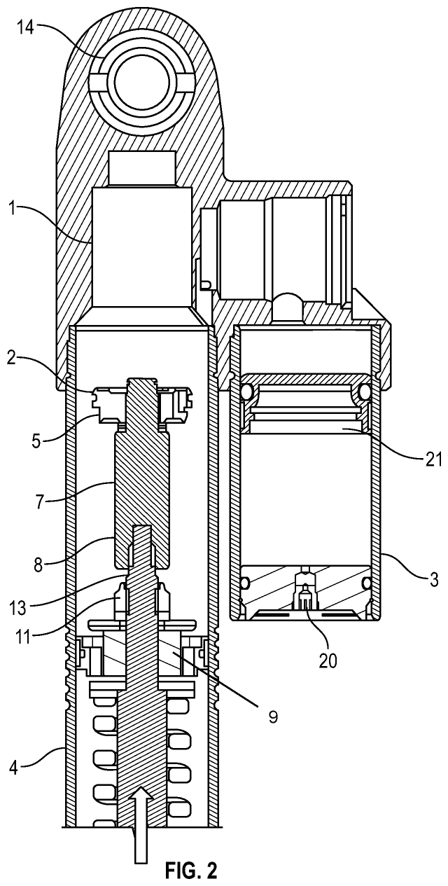

FIG. 2 is a close-up view of the upper portion of the embodiment illustrated in FIG. 1 in a first phase of operation. In a first stage of compression, the shock absorber operates as a conventional monotube, with the damping force being generated only by the main piston.

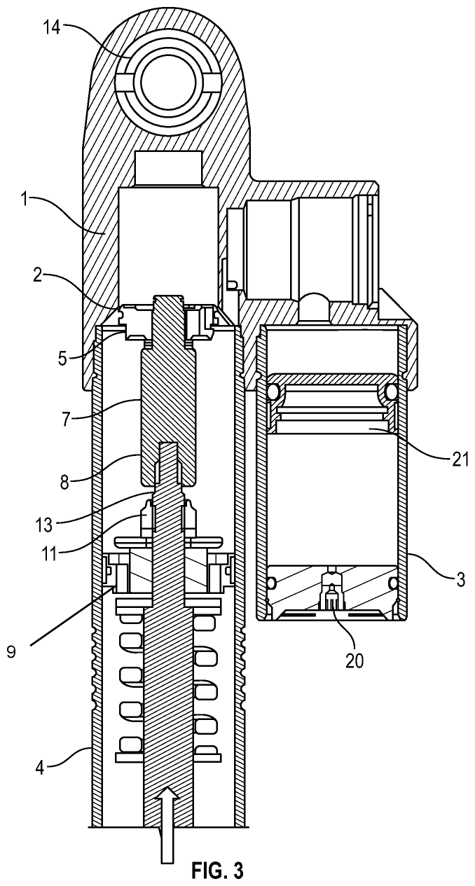

FIG. 3 is a close-up view of the upper portion of the embodiment illustrated in FIG. 1 in a second phase of operation. In a second stage, where the load on the shock absorber becomes greater, the compression piston travels into the body cap with hydraulic compression housing, but the shock absorber still operates as a monotube damper.

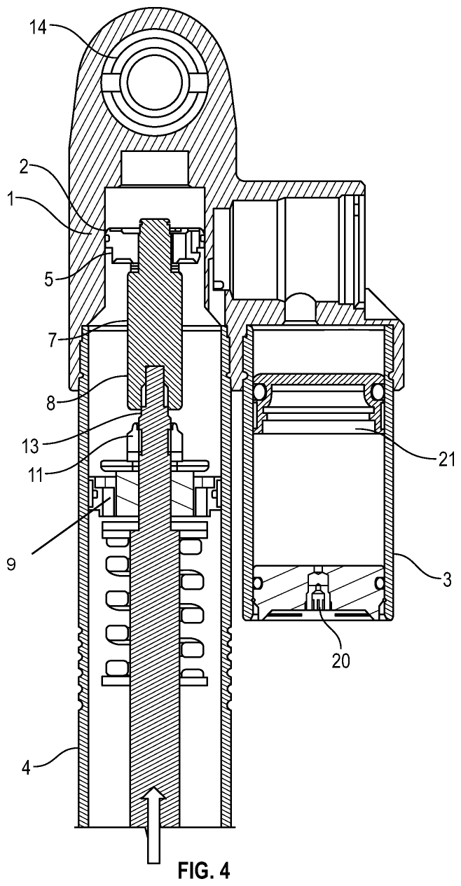

FIG. 4 is a close-up view of the upper portion of the embodiment illustrated in FIG. 1 in a third phase of operation. In a third stage, the compression piston significantly increases its compression damping force by supplementing the main piston. The oil volume in the compression piston passes through the compression piston, causing an increase in compression damping force.

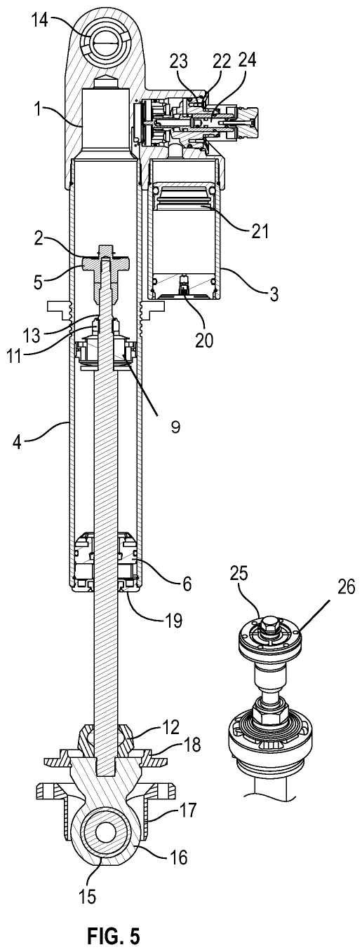

FIG. 5 is a cross-sectional view of a second embodiment of the invention with a close-up view of the check disc portion of the invention. In this second embodiment of the invention, a check disc 2 and a hydraulic jounce piston 5 are attached directly to a top section of the damper shaft with hydraulic jounce post 13, rather than using a hydraulic jounce piston valve stack as an intermediary member. A shock absorber has an upper eyelet 16 with an upper bushing 15, which at attached to a top mount plate 17, held in place by a jounce bumper 12 and an upper spring seat 18. There is a lower bushing with bar-pin 14 for attachment to a vehicle. A body cap with hydraulic compression 1 sits above a damper body 4.

The damper body 4 is bounded by a jounce cap 19, which a connected to the damper body by a seal head assembly 6. Inside the damper body 4, a damper shaft with hydraulic jounce post 13 connects the upper eyelet 16 to various pistons. A main working piston nut 11 secures a main working piston 9 to the damper shaft with hydraulic jounce post 13.

In this embodiment, the check disk 2 has one or more flow paths 26, where the check disc is attached to the top of the main piston, and wherein the check disc prevents suction or vacuum from building up in the compression cavity, as oil can pass through the one or more flow paths 26 in the check disc 25.

To the side of the body cap with hydraulic compression 1, is a reservoir body 3. The reservoir body 3 has a gas fill plug assembly 20 which is used to fill the reservoir body. Inside the reservoir body 3, an oil/gas separating piston 21 provides additional shock absorbing capabilities. Connecting the reservoir body 3 to the damper body 4 are an adjustable base valve assembly 24, which comprises a base valve adjustment indicator 22 which shows what adjustable base valve setting is currently selected, a base valve adjustment indicator 23 which indicates the setting of the knob.

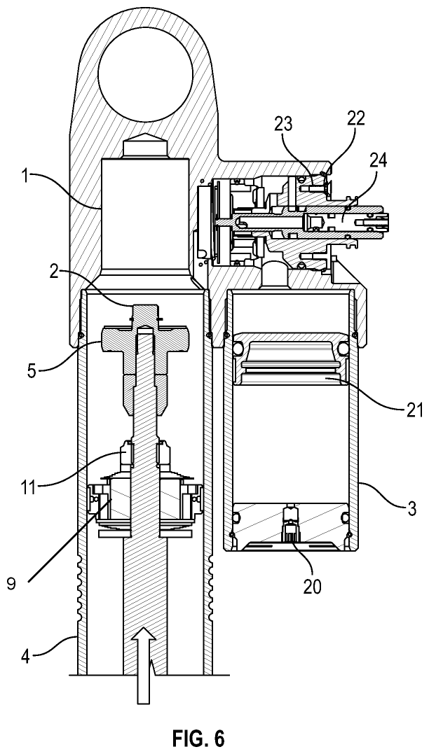

FIG. 6 is a close-up view of the upper portion of the embodiment illustrated in FIG. 5 in a first phase of operation. In a first stage of compression, the shock absorber operates as a conventional monotube, with the damping force being generated only by the main piston.

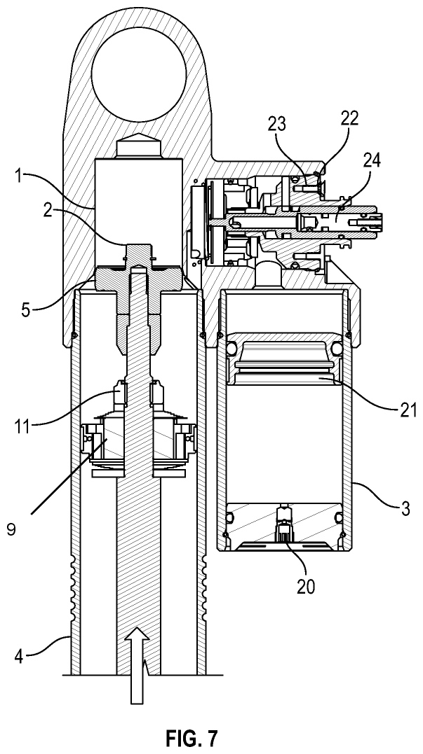

FIG. 7 is a close-up view of the upper portion of the embodiment illustrated in FIG. 5 in a second phase of operation. In a second stage, where the load on the shock absorber becomes greater, the compression piston travels into the body cap with hydraulic compression housing, but the shock absorber still operates as a monotube damper.

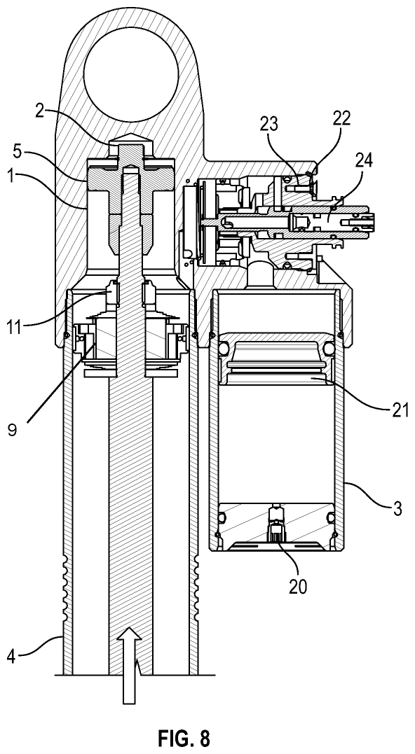

FIG. 8 is a close-up view of the upper portion of the embodiment illustrated in FIG. 5 in a third phase of operation. In a third stage, the compression piston significantly increases its compression damping force by supplementing the main piston. The oil volume in the compression piston passes through the compression piston, causing an increase in compression damping force.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A shock absorber device, consisting of a shock absorber body which has at an upper end an upper eyelet with an upper bushing, which is attached to a top mount plate and held in place by a jounce bumper and an upper spring seat, and at a lower end by a lower bushing with bar-pin;
wherein the shock absorber body has a damper body connected to a body cap with hydraulic compression;
wherein the damper body is bounded at an upper damper body end by a jounce cap, wherein the jounce cap is connected to the damper body by a seal head assembly;
wherein inside the damper body is a damper shaft with hydraulic jounce post which connects the upper eyelet to two pistons, wherein a main working piston nut secures a main working piston to the damper shaft with hydraulic jounce post;
wherein a check disc and a hydraulic jounce piston are attached directly to a top section of the damper shaft with hydraulic jounce post, wherein the check disc has one or more flow paths, wherein a quantity of oil can pass through the one or more flow paths in the check disc and prevent a buildup of vacuum in the body cap with hydraulic compression.

2. The device of claim 1, where the check Disk has one or more flow paths.

3. The device of claim 2, where the shock absorber functions in three phases, including a first stage, wherein during the first stage the shock absorber operates as a conventional monotube, with a damping force being generated only by the main piston.

4. The shock absorber of claim 4, where in a second stage, the compression piston travels into the body cap with hydraulic compression housing, as the shock absorber still operates as a monotube damper.

5. The shock absorber of claim 5, where in a third stage, the compression piston is significantly increasing its compression damping force by supplementing the main piston as an oil volume in the compression piston passes through the compression piston, causing an increase in the compression damping force.

6. The shock absorber of claim 6, additionally comprising a reservoir body 3, where the reservoir body comprises a gas fill plug assembly which is used to fill the reservoir body, an oil/gas separating piston which provides an additional shock absorbing capability, and an adjustable base valve assembly which connects the reservoir body to the damper body, and where the adjustable base valve assembly comprises a base valve adjustment indicator and a base valve adjustment indicator.

7. A shock absorber device, comprising a shock absorber body which has at an upper end an upper eyelet with an upper bushing, which is attached to a top mount plate and held in place by a jounce bumper and an upper spring seat, and at a lower end by a lower bushing with bar-pin;
wherein the shock absorber body has a damper body connected to a body cap with hydraulic compression;
wherein the damper body is bounded at an upper damper body end by a jounce cap, wherein the jounce cap is connected to the damper body by a seal head assembly;
wherein inside the damper body is a damper shaft with hydraulic jounce post which connects the upper eyelet to two pistons, wherein a main working piston nut secures a main working piston to the damper shaft with hydraulic jounce post;
wherein a check disc and a hydraulic jounce piston are attached directly to a top section of the damper shaft with hydraulic jounce post, wherein the check disc has one or more flow paths, wherein a quantity of oil can pass through the one or more flow paths in the check disc and prevent a buildup of vacuum in the body cap with hydraulic compression.

8. The device of claim 7, where the device functions in three phases, including a first stage, the shock absorber operates as a conventional monotube, with a damping force being generated only by the main piston.

9. The shock absorber of claim 8, where in a second stage, the compression piston travels into the body cap with hydraulic compression housing, as the shock absorber still operates as a monotube damper.

10. The shock absorber of claim 9, where in a third stage, the compression piston is significantly increasing its compression damping force by supplementing the main piston as an oil volume in the compression piston passes through the compression piston, causing an increase in the compression damping force.

11. The shock absorber of claim 10, additionally comprising a reservoir body 3, where the reservoir body comprises a gas fill plug assembly which is used to fill the reservoir body, an oil/gas separating piston which provides an additional shock absorbing capability, and an adjustable base valve assembly which connects the reservoir body to the damper body, and where the adjustable base valve assembly comprises a base valve adjustment indicator and a base valve adjustment indicator.

12. The shock absorber of claim 11, where in a first stage, the shock absorber operates as a conventional monotube, with a damping force being generated only by the main piston, where the shock absorber functions in three phases.

13. The shock absorber of claim 12, where in a second stage, the compression piston travels into the body cap with hydraulic compression housing, as the shock absorber still operates as a monotube damper.

14. The shock absorber of claim 13, where in a third stage, the compression piston is significantly increasing its compression damping force by supplementing the main piston as an oil volume in the compression piston passes through the compression piston, causing an increase in the compression damping force.

15. A shock absorber device, comprising a shock absorber body which has at an upper end an upper eyelet with an upper bushing, which is attached to a top mount plate and held in place by a jounce bumper and an upper spring seat, and at a lower end by a lower bushing with bar-pin;
wherein the shock absorber body has a damper body connected to a body cap with hydraulic compression;
wherein the damper body is bounded at an upper damper body end by a jounce cap, wherein the jounce cap is connected to the damper body by a seal head assembly;
wherein inside the damper body is a damper shaft with hydraulic jounce post which connects the upper eyelet to two pistons, wherein a main working piston nut secures a main working piston to the damper shaft with hydraulic jounce post;
wherein a check disc and a hydraulic jounce piston are attached to a hydraulic jounce piston valve stack, and wherein the hydraulic jounce piston valve stack is attached to a top section of the damper shaft with hydraulic jounce post, wherein the check disc has one or more flow paths, wherein a quantity of oil can pass through the one or more flow paths in the check disc and prevent a buildup of vacuum in the body cap with hydraulic compression.

16. The device of claim 7, where the device functions in three phases, including a first stage, the shock absorber operates as a conventional monotube, with a damping force being generated only by the main piston.

17. The shock absorber of claim 8, where in a second stage, the compression piston travels into the body cap with hydraulic compression housing, as the shock absorber still operates as a monotube damper.

18. The shock absorber of claim 9, where in a third stage, the compression piston is significantly increasing its compression damping force by supplementing the main piston as an oil volume in the compression piston passes through the compression piston, causing an increase in the compression damping force.

19. The shock absorber of claim 10, additionally comprising a reservoir body 3, where the reservoir body comprises a gas fill plug assembly which is used to fill the reservoir body, an oil/gas separating piston which provides an additional shock absorbing capability, and an adjustable base valve assembly which connects the reservoir body to the damper body, and where the adjustable base valve assembly comprises a base valve adjustment indicator and a base valve adjustment indicator.

20. The device of claim 19, where the device functions in three phases, including a first stage, the shock absorber operates as a conventional monotube, with a damping force being generated only by the main piston, where in a second stage, the compression piston travels into the body cap with hydraulic compression housing, as the shock absorber still operates as a monotube damper, where in a third stage, the compression piston is significantly increasing its compression damping force by supplementing the main piston as an oil volume in the compression piston passes through the compression piston, causing an increase in the compression damping force.
